(19) United States
(12) Patent Application Publication
(10) Pub. No.: US 2023/0267854 A1
(43) Pub. Date: Aug. 24, 2023

(54) ANATOMICAL MOVEMENT SIMULATION ASSEMBLY AND METHOD THEREOF

(71) Applicant: The Regents of the University of Michigan, Ann Arbor, MI (US)

(72) Inventors: David A. ZOPF, Dexter, MI (US); Amy K. PORTER, Ann Arbor, MI (US)

(21) Appl. No.: 18/112,368

(22) Filed: Feb. 21, 2023

Related U.S. Application Data
(60) Provisional application No. 63/311,562, filed on Feb. 18, 2022.

(51) Int. Cl. G09B 23/32

(52) U.S. Cl. CPC G09B 23/32

(57) ABSTRACT

An anatomical movement simulation assembly and a method of simulating anatomical movements. One or more additive-manufactured body part models anatomically approximates a corresponding physical body part(s), or exhibits anatomical accuracy relative to the corresponding physical body part(s). The physical body part(s) modeled include a rib cage, lungs, diaphragm, tongue, jaw and teeth, vocal folds, and larynx, among other possibilities. Movement is imparted to the additive-manufactured body part model(s), for instance via pump, motor, or manual actuation, in order to replicate the physiologically normal movement of the corresponding physical body part(s). Educators, musicians, singers, actors, students, doctors, and patients, as well as others, may find productive use observing such anatomical movement simulations.

### TECHNICAL FIELD

This disclosure relates generally to anatomical simulations and, more particularly, relates to simulating movements of human body parts for educational, medical, and other demonstrative and observational uses and purposes.

### BACKGROUND

Demonstrating and observing anatomical movements of human body parts can be useful in many settings. Educators, musicians, singers, actors, performers, clinicians, students, and patients, as well as perhaps others, may find it beneficial to demonstrate and observe body parts as the body parts normally function and move during different activities. For instance, understanding the physiology of breathing and the anatomy of sound can be central to producing high quality musical tones in woodwind instruments like the flute. Movements related to a diaphragm and vocal folds may hence be particularly worthwhile to aspiring musicians amid their education and lessons. Other examples include the demonstration of body part movements for medical students in training.

Previous efforts to demonstrate movements of human body parts, such as the lungs and diaphragm for musicians, have involved physically touching a student's chest in an educational setting, and have involved displaying the movements on a video screen. These efforts, while sufficient in some regards, have become culturally inappropriate in the case of physical touching, and may lack the instructive impact desired.

### SUMMARY

According to an aspect of the disclosure, a method of simulating anatomical movements may have several steps. The method may involve providing one or more additive-manufactured body part models. The additive-manufactured body part model(s) anatomically approximates a corresponding physical body part subject to the modeling. The method may further involve effecting movement of the additive-manufactured body part model(s). The effected movement replicates physiologically normal movement of the corresponding physical body part.

According to another aspect of the disclosure, an anatomical movement simulation assembly may include a first additive-manufactured body part model, a second additive-manufactured body part model, and an actuator. The first additive-manufactured body part model may exhibit substantial anatomical accuracy with respect to a corresponding first physical body part subject to the modeling. The second additive-manufactured body part model may exhibit substantial anatomical accuracy with respect to a corresponding second physical body part subject to the modeling. The actuator may interact with the first additive-manufactured body part model. Upon actuation of the actuator, the first additive-manufactured body part model moves with respect to the second additive-manufactured body part model. The second additive-manufactured body part model remains static during the movement of the first additive-manufactured body part model.

### BRIEF DESCRIPTION OF THE DRAWINGS

Exemplary embodiments will hereinafter be described in conjunction with the appended drawings, wherein like designations denote like elements, and wherein:

FIG. 1 is a schematic of an embodiment of an anatomical movement simulation assembly;

FIG. 2 shows a layout of some components of the anatomical movement simulation assembly according to an embodiment;

FIG. 3A shows an embodiment of a mold set used to prepare an additive-manufactured body part model of the anatomical movement simulation assembly;

FIG. 3B shows an embodiment of a mold set used to prepare an additive-manufactured body part model of the anatomical movement simulation assembly;

FIGS. 4A and 4B demonstrate movement of a physical body part subject to modeling in an embodiment of the anatomical movement simulation assembly; and

FIG. 5 is a flowchart of an embodiment of a method of simulating anatomical movements.

### DETAILED DESCRIPTION

Embodiments of an anatomical movement simulation assembly and of a method of simulating anatomical movements are presented. One or more additive-manufactured body part models are employed in the larger assembly and amid use of the method, according to the embodiments. The additive-manufactured body part model(s) can be made to anatomically approximate a corresponding physical human body part(s) that is subject to the rendered representation, or the additive-manufactured body part model(s) can exhibit substantial anatomical accuracy relative to the corresponding physical human body part(s). Unlike past efforts, the movement simulated is meant to reproduce physiologically normal and healthy and accurate functioning of the corresponding physical human body part(s). Depending on the embodiment, the anatomical movement simulation assembly can take the form of a toolkit that is more readily accessible for certain users and in certain applications, such as for professors and teachers in an educational setting. The anatomical movement simulation assembly and accompanying method are suitable in a wide range of applications including, but not limited to, education, training, rehabilitation, speech therapy, military, and other demonstrative and observational purposes. Educators, musicians, singers, actors, performers, students, doctors, clinicians, trainers, speech and language pathologists, occupational therapists, and soldiers, are among those that may find ready use of the anatomical movement simulation assembly and method described herein.

As used herein, and for purposes of describing anatomical accuracy, the term “substantially” is intended to account for the inherent degree of variance and imprecision that is often attributed to, and often accompanies, any design and manufacturing process, including engineering tolerances. In this regard, the phrase “substantial anatomical accuracy” does not mean modeling physical human body parts with strict exactitude.

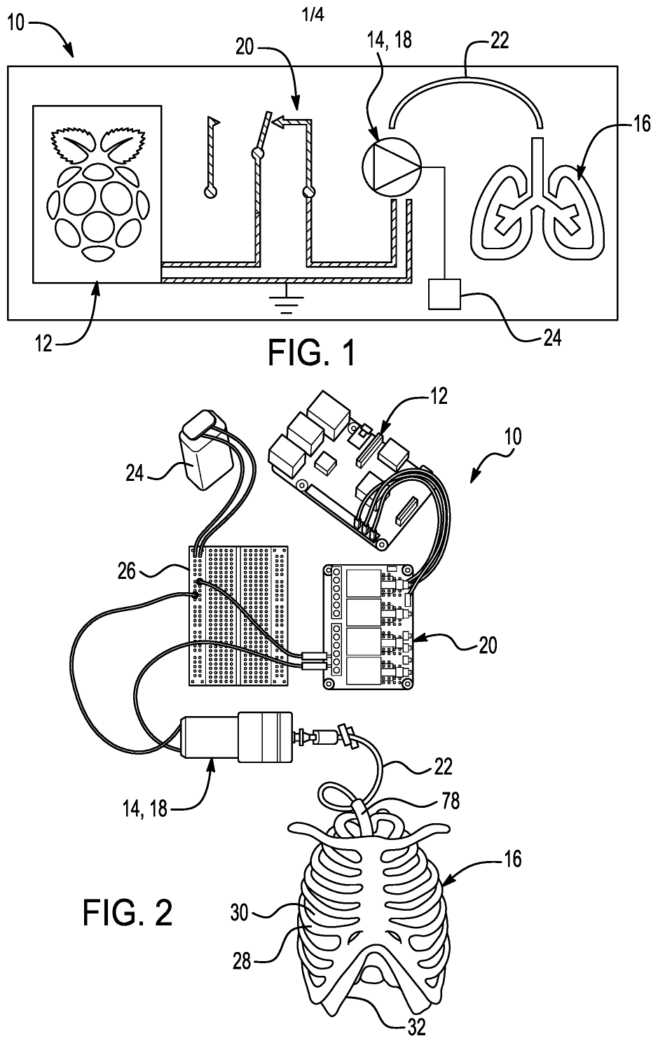

The anatomical movement simulation assembly and accompanying method can vary in different embodiments depending upon—among other possible factors—the particular physical body part for which a model is rendered, and the intended movement to be imparted to the additive-manufactured body part model(s). It will become apparent to skilled artisans as this description advances that the assembly could have more, less, and/or different components than those set forth with reference to the figures, and that the method could have more, less, and/or different steps than those described herein. FIG. 1 presents an embodiment of an anatomical movement simulation assembly 10 in diagrammatic form. In this embodiment, the anatomical movement simulation assembly 10 includes—at a general level—a controller 12, an actuator 14, and an additive-manufactured body part model 16. This embodiment is particularly aimed at replicating the physiology of respiration and breathing, as described in more detail below, and hence may be particularly beneficial to musicians like woodwind instrument players, for example.

The controller 12 serves as a user input for regulating operation and movement of the additive-manufactured body part model 16. Depending on the embodiment, the user may activate (i.e., ON) and deactivate (i.e., OFF) the movement of the additive-manufactured body part model 16 via the controller 12, and may speed or slow the pace of the movement of the additive-manufactured body part model 16 via the controller 12. Command signals may be sent from the controller 12 and to the actuator 14. The controller 12 can take different forms in different embodiments. In the embodiment of FIG. 1, the controller 12 is in the form of a Raspberry Pi 3 single-board computer provided by the Raspberry Pi Foundation headquartered in Cambridge, England, United Kingdom. The Raspberry Pi 3 computer runs the software system Wolfram Mathematica provided by Wolfram Research, Inc. headquartered in Champaign, Ill., United States, according to this embodiment. The user input can include a computer keyboard and computer monitor electrically connected to the Raspberry Pi 3 computer via a USB port and cable connection. Still, the controller 12 could include other types of hardware and software applications in other embodiments. The controller 12 could be in the form of a mobile application for a mobile device like a mobile phone or tablet. Further, the controller 12 could be in the form of a wired control device or a wireless remote-control device that provides activation and deactivation of the actuator 14, and/or provides adjustments to the pace of the imparted movement. In an embodiment, command signals can be communicated via certain wireless communication protocols and communication hardware such as Bluetooth, Wi-Fi, and other wireless technologies.

The actuator 14 can receive command signals from the controller 12, and serves to impart movement to the additive-manufactured body part model 16. The actuator 14 interacts with the additive-manufactured body part model 16 in order to impart the movement. The interaction can involve a fluid line connection in the case of pump actuation, and can involve a mechanical connection with intermediate components in the case of motor actuation. The actuator 14 can take different forms in different embodiments, its form being dictated in part by the additive-manufactured body part model 16 and the movement to be imparted by it. In the embodiment of FIG. 1, the actuator 14 is in the form of an air pump 18. Here, the air pump 18 electrically communicates with the controller 12 via an electromechanical relay 20, and is connected to the additive-manufactured body part model 16 via an airline 22. The airline 22 can be a plastic tubing or a rubber tubing. A battery 24 supplies power to the air pump 18. The battery 24 can be a 9 Volt battery in an example, or could have some other voltage value depending on the pump. When activated and actuated, the air pump 18 generates pressure and provides inflation to the additive-manufactured body part model 16; and conversely, when de-actuated, the air pump 18 depressurizes and provides deflation to the additive-manufactured body part model 16. Still, when in the form of a pump, the actuator 14 could be of the following pump types, among other possibilities: an electric peristaltic pump, an electric diaphragm pump, an electric piston pump, an electric gear pump, an electric rotary pump, an electric progressing cavity pump, or an electric syringe pump. The pump could also be a manual, hand-operated syringe pump; in this embodiment, actuation would occur by manual actuation, and the controller 12 would be altogether absent. Other kinds of manual actuation can involve more direct physical manipulation by a user. Further, in other embodiments, the actuator 14 can be in the form of an electric motor. The electric motor embodiment may be most employable when the movement to be imparted involves forward and rearward movements, upward and downward movements, side to side movements, and opening and closing movements.

The additive-manufactured body part model 16 is a rendered representation of a corresponding physical human body part. The rendered representation is designed and constructed to anatomically approximate the corresponding physical human body part, or can exhibit substantial anatomical accuracy with respect to the corresponding physical human body part. The approximation and substantial accuracy described here is in terms of geometry, size, and shape relative to the corresponding physical human body part; is in terms of movement of the corresponding physical human body part (i.e., where movement is applicable); and can be in terms of position and orientation with respect to adjacent body parts. In different embodiments, the corresponding physical human body part could be an organ, a muscle, a bone, or some other part of the human body. Further, the additive-manufactured body part model 16 is made by an additive manufacturing fabrication process such as a three-dimensional (3D) printing process. In one embodiment, a stereolithography (SLA) 3D printing process is employed to prepare the additive-manufactured body part model 16. In another embodiment, a fused deposition modeling 3D printing process is employed to prepare the additive-manufactured body part model 16. Still, other additive manufacturing technologies and techniques can be carried out in other embodiments. The additive-manufactured body part model 16 can take different forms. In the embodiment of FIG. 1, the additive-manufactured body part model 16 is in the form of an assemblage of models: a rib cage model, a lungs model, and a diaphragm model.

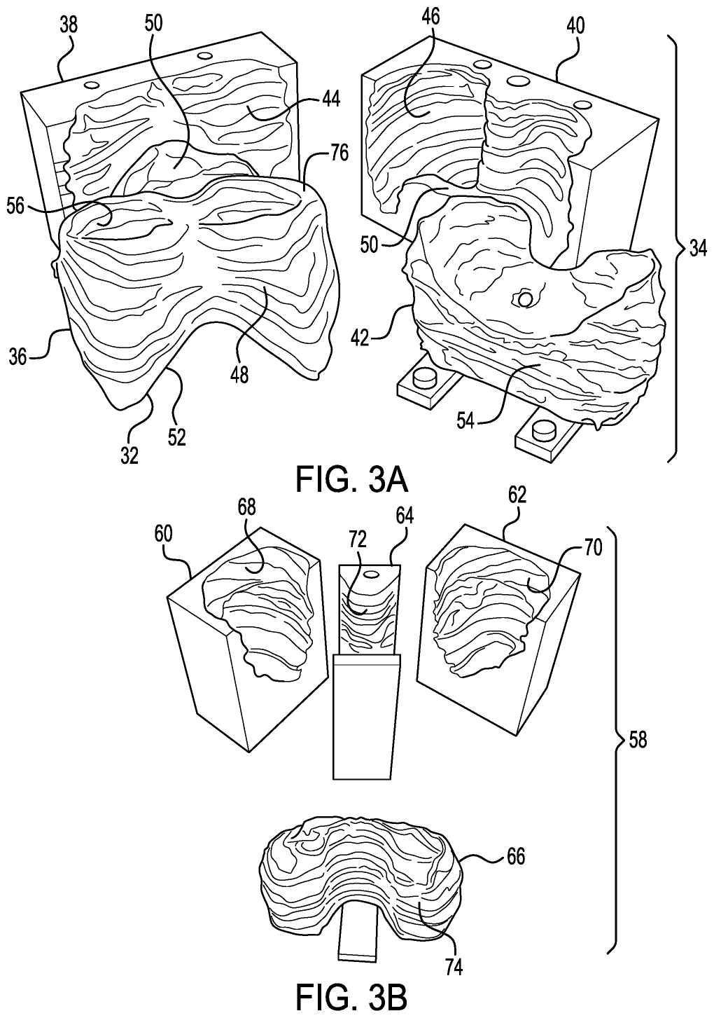

FIG. 2 presents an embodiment of the anatomical movement simulation assembly 10 in a more appreciable form. The components that make-up the anatomical movement simulation assembly 10 can be packaged together in this embodiment to comprise a toolkit that is more readily accessible and useable for educators, per an example. The Raspberry Pi 3 controller 12 is electrically connected and wired to the electromechanical relay 20, which itself is electrically connected and wired to an electronic breadboard 26 and to the air pump 18. The battery 24 is also electrically connected and wired to the electronic breadboard 26. The additive-manufactured body part model 16 in the embodiment of FIG. 2 includes a rib cage model 28, a lungs model 30, and a diaphragm model 32. The rib cage model 28 was prepared from a photosensitive resin polymer material and via a stereolithography (SLA) 3D printing process; still, other additive manufacturing fabrication processes and procedures can be carried out to make the rib cage model 28. The lungs model 30 and diaphragm model 32 were prepared via a negative mold set assembly of FIGS. 3A and 3B. The lungs model 30 and diaphragm model 32 establish a hollow interior and are composed of a silicone rubber material with a shore hardness of 10 A, per an example, in order to exhibit a balloon-like behavior of inflation and deflation relative to the rib cage model 28 amid use. The negative mold set assembly according to this embodiment was prepared from a polylactic acid (PLA) plastic material and via a fused deposition modeling 3D printing process.

FIG. 3A depicts a bottom mold half 34 of the negative mold set assembly used to make a bottom portion 36 of the lungs model 30 with the diaphragm model 32. The bottom mold half 34 includes a first external mold part 38, a second external mold part 40, and an interior core part 42. The first and second external mold parts 38, 40 have inner surfaces 44, 46 that are detailed to mimic an exterior skin and contour of a corresponding human lungs subject to the modeling, and that establish an outer surface 48 of the lungs model 30 at the bottom portion 36. In a similar manner, lower surfaces 50 of the first and second external mold parts 38, 40 are detailed to mimic an exterior skin and contour of a corresponding human diaphragm subject to the modeling. The lower surfaces 50 establish an outer surface 52 of the diaphragm model 32. Further, the interior core part 42 has an outer surface 54 that is detailed to mimic an interior skin and contour of the corresponding human lungs subject to the modeling, and that establishes an inner surface 56 of the lungs model 30 at the bottom portion 36. In assembly and use, the first and second external mold parts 38, 40 are brought together and sandwich the interior core part 42 residing therebetween. Together, the surfaces 44, 46, 50, 54 define a cavity for an injection molding preparation procedure in which, per an example, a silicone rubber material in a molten state is injected into the cavity and subsequently solidified. Once the procedure is complete, the bottom portion 36 of the lungs model 30 and the diaphragm model 32 are formed. The bottom portion 36 of the lungs model 30 and the diaphragm model 32 constitute a monolithic formation. The diaphragm model 32 is a dome-shaped wall spanning across, and closing, a bottom side of the lungs model 30.

FIG. 3B depicts a top mold half 58 of the negative mold set assembly used to make a top portion of the lungs model 30. The top portion is complementary to the bottom portion 36 so that the two portions can be joined together. The top mold half 58 includes a first external mold part 60, a second external mold part 62, a third external mold part 64, and an interior core part 66. The first, second, and third external mold parts 60, 62, 64 have inner surfaces 68, 70, 72 that are detailed to mimic an exterior skin and contour of the corresponding human lungs subject to the modeling, and that establish the outer surface 48 of the lungs model 30 at the top portion. In a similar manner, the interior core part 66 has an outer surface 74 that is detailed to mimic an interior skin and contour of the corresponding human lungs subject to the modeling, and that establishes an inner surface of the lungs model 30 at the top portion. In assembly and use, the first, second, and third external mold parts 60, 62, 64 are brought together and sandwich the interior core part 66 residing therebetween. Together, the surfaces 68, 70, 72, 74 define a cavity for an injection molding preparation procedure in which, per an example, a silicone rubber material in a molten state is injected into the cavity and subsequently solidified. Once the procedure is complete, the top portion is formed. The top portion and bottom portion 36 can then be married and adhered together by applying epoxy at open ends 76 thereof. The adherence of the top and bottom portions establishes an air-tight hollow interior of the lungs model 30. Still, other additive manufacturing fabrication processes and procedures can be carried out to make the lungs model 30 and the diaphragm model 32.

According to the embodiment of the figures, the lungs model 30 is inserted and received within the rib cage model 28, as illustrated in FIG. 2. By way of the additive manufacturing fabrication processes and procedures, the rib cage model 28 anatomically approximates a corresponding human rib cage subject to the modeling at least in terms of its geometry, size, and shape. Moreover, the rib cage model 28 can exhibit substantial anatomical accuracy with respect to the corresponding human rib cage. Similarly, the lungs model 30 anatomically approximates the corresponding human lungs subject to the modeling at least in terms of its geometry, size, and shape, as well as in terms of its movability and its position and orientation with respect to the rib cage model 28. Moreover, the lungs model 30 can exhibit substantial anatomical accuracy with respect to the corresponding human lungs. Further, the diaphragm model 32 anatomically approximates the corresponding human diaphragm subject to the modeling at least in terms of its geometry, size, and shape, as well as in terms of its movability and its position and orientation with respect to the rib cage model 28 and the lungs model 30. Moreover, the diaphragm model 32 can exhibit substantial anatomical accuracy with respect to the corresponding human diaphragm.

In use, according to this embodiment, the lungs model 30 and the diaphragm model 32 are moveable upon actuation with respect to the rib cage model 28. The rib cage model 28 remains static in comparison to the movement of the lungs and diaphragm models 30, 32, and itself is not actuatable for imparting movement. Maintaining reference to FIG. 2, the airline 22 plugs into a stem and port 78 of the lungs model 30. The air pump 18 inflates and deflates the lungs model 30. The lungs model 30, in turn, expands and contracts with respect to the rib cage model 28. The imparted movement to the lungs model 30 replicates inhalation and exhalation of the corresponding human lungs subject to the modeling. In this embodiment, the Mathematica software application of the Raspberry Pi 3 controller 12 can be programmed to command and control the rate of inflation and deflation in order to match a human's normal respiratory rate, if desired; still, in other embodiments other software applications and other measures can be implemented to control the rate of inflation and deflation. The rate of inflation and deflation could also be set to match respiratory rates in other circumstances, such as that of a musician during a performance, as but one example. In other examples, a human subject's chest expansion and contraction, manometry, and/or respiratory rate, among other human movements, can be synchronized in real-time with the simulated movement of the additive-manufactured body part model 16. This real-time physiology provides the human subject whether that be a musician or a patient or someone else—a visual sense of biofeedback of one's own physiological movement. Concurrently, the diaphragm model 32 moves outward and downward with respect to the rib cage model 28 when the lungs model 30 is inflated, and the diaphragm model 32 moves inward and upward with respect to the rib cage model 28 when the lungs model 30 is deflated. The imparted outward movement of the diaphragm model 32 replicates inferior movement of the corresponding human diaphragm subject to the modeling when it contracts and tightens upon inhalation. Conversely, the imparted inward movement of the diaphragm model 32 replicates superior movement of the corresponding human diaphragm when it relaxes upon exhalation.

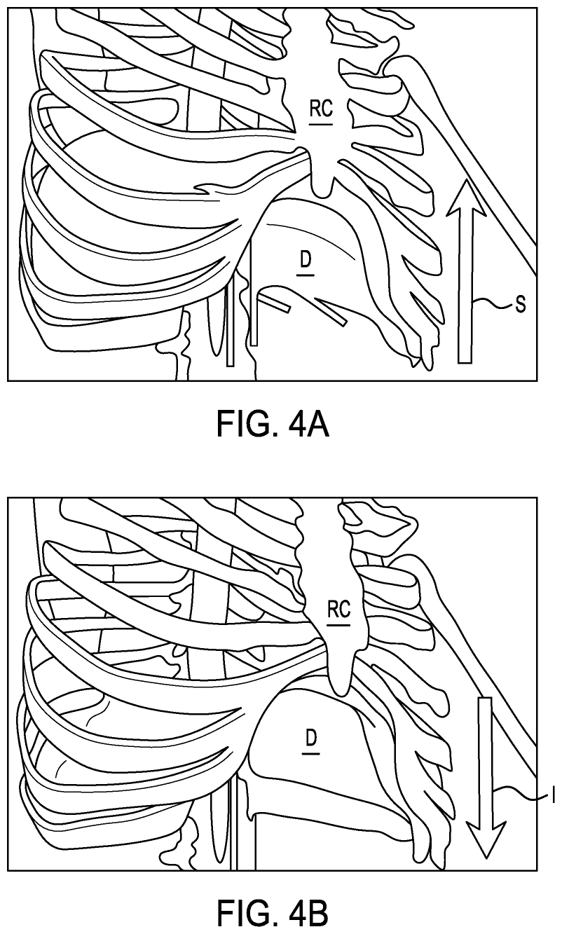

The movement imparted and simulated is intended to reproduce and emulate physiologically normal, healthy, and substantially accurate functioning and movement of the particular corresponding physical human body part subject to the modeling. The simulated movement replicates normal movement and behavior observed in a human body. In the embodiment of the figures, for instance, the inflation and deflation and attendant expansion and contraction movements of the lungs model 30 reproduce the physiologically normal inhalation and exhalation movements of the corresponding human lungs subject to the modeling. In the example here, the properties of the rubber material of the lungs model 30 facilitates the replication. Likewise, the outward and inward movement, and downward and upward movement, of the diaphragm model 32 reproduces the physiologically normal inferior and superior movements of the corresponding human diaphragm subject to the modeling. FIGS. 4A and 4B demonstrate these inferior and superior movements. A corresponding human diaphragm D subject to the modeling moves superiorly (S arrow) when it relaxes during exhalation with respect to a rib cage RC, as shown in FIG. 4A. Conversely, the corresponding human diaphragm D moves inferiorly (I arrow) when it contracts and tightens during inhalation with respect to the rib cage RC, as shown in FIG. 4B.

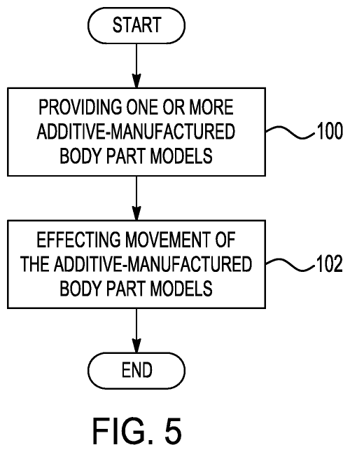

With reference now to FIG. 5, an embodiment of a method of simulating anatomical movements is presented in flowchart form. The method can employ the anatomical movement simulation assembly 10 in its implementation. The method could have more, less, and/or different steps than those set forth in FIG. 5. A step 100 of the method according to this embodiment involves providing one or more additive-manufactured body part models 16. The additive-manufactured body part model(s) 16 can include the rib cage model 28, lungs model 30, and diaphragm model 32, as well as other models described in this description. A further step 102 of the method involves effecting movement of the additive-manufactured body part model(s) 16. The movement effected can be that described elsewhere in this description, such as inflation and deflation of the lungs model 30, as well as outward and inward movement of the diaphragm model 32. Other steps of the method, per various embodiments, may include approximating a corresponding physical body part subject to the modeling, controlling and regulating the effected movement of the additive-manufactured body part model(s) 16, and/or actuating the additive-manufactured body part model(s) 16 in order to impart the effected movement such as via pump actuation, motor actuation, or manual actuation.

Still, the anatomical movement simulation assembly 10 has other designs, constructions, and components in other embodiments. In a first alternative embodiment, the additive-manufactured body part model 16 is in the form of an assemblage of models: a tongue model and a jaw and teeth model. The tongue model anatomically approximates a corresponding human tongue subject to the modeling at least in terms of its geometry, size, and shape, as well as in terms of its movability and its position and orientation relative to the jaw and teeth model. Moreover, the tongue model can exhibit substantial anatomical accuracy with respect to the corresponding human tongue. Similarly, the jaw and teeth model anatomically approximates a corresponding human jaw and teeth subject to the modeling at least in terms of its geometry, size, and shape, and can exhibit substantial anatomical accuracy with respect to the corresponding human jaw and teeth. In use, according to this first alternative embodiment, the tongue model is moveable upon actuation with respect to the jaw and teeth model. The tongue model can move forward and rearward relative to the jaw and teeth model, can move upward and downward relative to the jaw and teeth model, or the movement can be a blended movement of forward and rearward and upward and downward movements. The tongue model could also move side-to-side. Actuation per this embodiment can occur via pump actuation, motor actuation, or manual actuation. Furthermore, as in previous embodiments, the movements of the tongue model are intended to reproduce and emulate the physiologically normal movements of the corresponding human tongue subject to the modeling. Moreover, in a somewhat related embodiment, a lips model could also be provided in addition to, or in lieu of, one or more of the tongue model and jaw and teeth model; the assemblage of models here could be employed to produce speech-like sounds amid their use.

In a second alternative embodiment, the additive-manufactured body part model 16 is in the form of an assemblage of models: a vocal folds model (also called vocal cords) and a larynx model (also called a voice box). The vocal folds model anatomically approximates a corresponding human vocal folds subject to the modeling at least in terms of its geometry, size, and shape, as well as in terms of its movability and its position and orientation relative to the larynx model. Moreover, the vocal folds model can exhibit substantial anatomical accuracy with respect to the corresponding human vocal folds. Similarly, the larynx model anatomically approximates a corresponding human larynx subject to the modeling at least in terms of its geometry, size, and shape, and can exhibit substantial anatomical accuracy with respect to the corresponding human larynx. In use, according to this second alternative embodiment, the vocal folds model is moveable upon actuation with respect to the larynx model. The vocal folds model can open and close relative to the larynx model. Actuation per this embodiment can occur via pump actuation or motor actuation. Furthermore, as in previous embodiments, the movements of the vocal folds model are intended to reproduce and emulate the physiologically normal movements of the corresponding human vocal folds subject to the modeling. The physiologically normal movements of the corresponding human vocal folds can involve an undulated and wavelike motion.

Lastly, the additive-manufactured body part model 16 can be in the form of a neck model, a wrist model, a hand with fingers model, an ankle model, a foot with toes model, a knee model, a hip model, an elbow model, and a shoulder model.

It is to be understood that the foregoing description is of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of simulating anatomical movements, the method comprising:
providing at least one additive-manufactured body part model, the at least one additive-manufactured body part model anatomically approximating a corresponding physical body part(s) subject to the modeling; and
effecting movement of the at least one additive-manufactured body part model, wherein the effected movement replicates physiologically normal movement of the corresponding physical body part(s).

2. The method as set forth in claim 1, wherein the at least one additive-manufactured body part model exhibits substantial anatomical accuracy with respect to the corresponding physical body part(s).

3. The method as set forth in claim 1, further comprising effecting movement via at least one of a pump actuation, motor actuation, or manual actuation.

4. The method as set forth in claim 1, wherein the at least one additive-manufactured body part model is a three-dimensional-printed body part model.

5. The method as set forth in claim 1, wherein effecting movement of the at least one additive-manufactured body part model involves activation via wireless user commands.

6. The method as set forth in claim 1, wherein the at least one additive-manufactured body part model comprises a rib cage model, a lungs model, and a diaphragm model.

7. The method as set forth in claim 6, wherein the movement effected involves inflation and deflation of the lungs model with respect to the rib cage model, involves outward and inward movement of the diaphragm model with respect to the rib cage model, or involves both inflation and deflation of the lungs model with respect to the rib cage model and outward and inward movement of the diaphragm model with respect to the rib cage model.

8. The method as set forth in claim 7, wherein the inflation and deflation of the lungs model is via pump actuation or motor actuation.

9. The method as set forth in claim 1, wherein the at least one additive-manufactured body part model comprises a tongue model and a jaw and teeth model.

10. The method as set forth in claim 9, wherein the movement effected involves forward and rearward movement of the tongue model with respect to the jaw and teeth model, involves upward and downward movement of the tongue model with respect to the jaw and teeth model, or involves both forward and rearward of the tongue model with respect to the jaw and teeth model and upward and downward movement of the tongue model with respect to the jaw and teeth model.

11. The method as set forth in claim 10, wherein the movement of the tongue model is via pump actuation, motor actuation, or manual actuation.

12. The method as set forth in claim 1, wherein the at least one additive-manufactured body part model comprises a vocal folds model and a larynx model.

13. The method as set forth in claim 12, wherein the movement effected involves opening and closing movements of the vocal folds model with respect to the larynx model.

14. The method as set forth in claim 13, wherein the opening and closing movements of the vocal folds model is via pump actuation or motor actuation.

15. The method as set forth in claim 1, wherein the effected movement is synchronized with a human subject, and the effected movement replicates physiological movements of the human subject in real-time.

16. An anatomical movement simulation assembly, comprising:
a first additive-manufactured body part model, the first additive-manufactured body part model exhibiting substantial anatomical accuracy relative to a corresponding first physical body part subject to the modeling;
a second additive-manufactured body part model, the second additive-manufactured body part model exhibiting substantial anatomical accuracy relative to a corresponding second physical body part subject to the modeling; and
an actuator interacting with the first additive-manufactured body part model, wherein, upon actuation of the actuator, the first additive-manufactured body part model moves with respect to the second additive-manufactured body part model which remains static during the movement of the first additive-manufactured body part model.

17. The anatomical movement simulation assembly as set forth in claim 16, wherein the movement of the first additive-manufactured body part model replicates physiologically normal movement of the corresponding first physical body part subject to the modeling.

18. The anatomical movement simulation assembly as set forth in claim 16, wherein the first additive-manufactured body part model is at least one of a lungs model, a diaphragm model, a tongue model, or a vocal folds model.

19. The anatomical movement simulation assembly as set forth in claim 18, wherein the second additive-manufactured body part model is at least one of a rib cage model, a jaw and teeth model, or a larynx model.

20. The anatomical movement simulation assembly as set forth in claim 19, wherein the movement of the first additive-manufactured body part model involves at least one of inflation and deflation, outward and inward movement, forward and rearward movement, upward and downward movement, or opening and closing movement.

21. The anatomical movement simulation assembly as set forth in claim 16, wherein the actuator is a pump or a motor.
